(19) United States
(12) Patent Application Publication
(10) Pub. No.: US 2015/0244844 A1
(43) Pub. Date: Aug. 27, 2015

(54) COMMUNICATION SYSTEM

(71) Applicants: David G. Butler, Eagle, ID (US); Kenneth K Smith, Boise, ID (US)

(72) Inventors: David G. Butler, Eagle, ID (US); Kenneth K Smith, Boise, ID (US)

(21) Appl. No.: 14/423,876

(22) PCT Filed: Aug. 31, 2012
(86) PCT No.: PCT/US12/53493

§ 371 Date: Feb. 25, 2015

(51) Int. Cl. H04L 29/06; H04L 29/08

(52) U.S. Cl. CPC H04L 69/24; H04L 67/14; H04L 67/02

(57) ABSTRACT

A communication system is disclosed herein. An example of a communication system includes a network and a server including a port connected to the network. The communication system also includes a device connected to the network that communicates data over the network via a printing protocol or an HTTP protocol. The communication system additionally includes a communication module associated with the port of the server that establishes both a printing link that utilizes the printing protocol via the port of the server to transceive data over the network and an HTTP link that utilizes the HTTP protocol via the same port of the server to transceive the data over the network. A method of network communication and non-transitory storage medium are also disclosed herein.

### BACKGROUND

Management of networks can be complex. Networking technology changes and enhancements can result in time consuming and costly upgrades and modifications to legacy devices and peripherals that utilize older networking technology. Simplification of such legacy device and peripheral migration is therefore, desirable.

### BRIEF DESCRIPTION OF THE DRAWINGS

The following detailed description references the drawings, wherein:

FIG. 1 is an example of a communication system.

FIG. 2 is an example of a method of network communication.

FIG. 3 is an example of additional elements of the method of network communication of FIG. 2.

FIG. 4 is an example of a non-transitory storage medium.

FIG. 5 is an example of additional instructions ions that may be on the non-transitory storage medium of FIG. 4.

### DETAILED DESCRIPTION

Communication systems that utilize distributed and cloud-based networking technology provide advantages over systems that rely on more localized networking technology. This can present a dilemma, however, to enterprises that want to benefit from these advantages, but have legacy devices and/or peripherals that do not operate well or at all on such distributed or cloud-based networks.

Network print traffic on a communication system may utilize device port 9100 and HTTP traffic utilizes port 80. Secure HTTP traffic (i.e., HTTP layered with SST.) utilizes port 443. Internet Printing Protocol (“IPP”) is a relatively newer printing protocol that runs over HTTP, but requires re-implementation of existing functionality both in printers and printer driver software, Standard IPP also requires the consumption of another port or two and the associated network configuration at intermediate firewalls and routers, Extra “holes” must be “punched-through” firewalls to adapt this environment to cloud-based networking. Alternatively, custom network address translation (“NAT”) rules and unique hosts can be created to handle 9100 traffic and HTTP traffic.

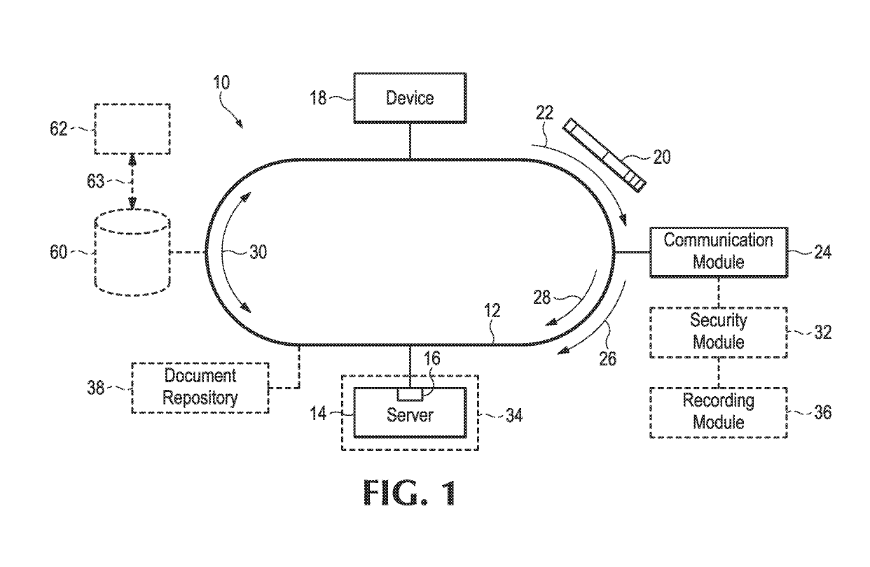

A communication system 10 directed to simplifying network administration of firewalls and servers in distributed and cloud-based environments is shown in FIG. 1. Communication system 10 helps migrate legacy devices and peripherals, such as printers and print drivers, to cloud-based networking without requiring extensive re-implementation of associated software and hardware. Communication system 10 also helps enable a content on-ramp to a document repository without requiring the installation of specialized hardware and/or software.

As used herein, the terms “non-transitory storage medium” and “non-transitory computer-readable storage medium” are defined as including, but not necessarily being limited to, any media that can contain, store, or maintain programs, information, and data. Non-transitory storage medium and non-transitory computer-readable storage medium may include any one of many physical media such as, for example, electronic, magnetic, optical, electromagnetic, or semiconductor media. More specific examples of suitable non-transitory storage medium and non-transitory computer-readable storage medium include, but are not limited to, a magnetic computer diskette such as floppy diskettes or hard drives, magnetic tape, a backed-up random access memory (RAM), a read-only memory (ROM), an erasable programmable read-only memory (EPROM), a flash drive, a compact disc (CD), or a digital video disk (DVD).

As used herein, the term “processor” is defined as including, but not necessarily being limited to, an instruction execution system such as a computer processor based system, an Application Specific Integrated Circuit (ASIC), a computing device, or a hardware and/or software system that can fetch or obtain the logic from a non-transitory storage medium or a non-transitory computer-readable storage medium and execute the instructions contained therein, “Processor” can also include any conf state-machine, microprocessor, cloud-based utility, service or feature, or any other analogue, digital and/or mechanical implementation thereof.

As used herein, “device” is defined as including, but not necessarily being limited to, a computer, phone, tablet, personal digital assistant, peripheral, document repository, storage array, or other similar device. As used herein, the term “network” is defined as including, but not necessarily being limited to, a collection of hardware (e.g., bridges, switches, routers, firewalls, etc. and software protocols, encryption, etc. components interconnected by communication channels (intranet, internet, cloud, etc.) that allow sharing of resources and information. The communication channels may be wired (e.g., coax, fiber optic, etc.) and/or wireless (e.g., 802.11, Bluetooth, etc.), use various protocols (e.g., TCP/IP, Ethernet, etc.), have different topologies (ring, bus, mesh, etc.), and be localized (e.g., LAN) or distributed (e.g., WAN).

As used herein, “server” is defined as including, but not necessarily being limited to, a computer dedicated to running or controlling one or more services (as a host) to serve the needs of users of other devices on a network. Examples include, but are not limited to, a database server, file server, mail server, print server, web server, gaming server, etc. As used herein, “peripheral” is defined as including, but not necessarily being limited to, a device connected to another device or network, that expands the capabilities of the other device, such as a printer, scanner, camera, fax machine, or storage device.

As used herein, “traffic” is defined as including, but not necessarily being limited to, messages, data, or information transmitted or communicated over a network in a particular format and manner (e.g., protocol). As used herein, “port” is defined as including, but not necessarily being limited to, an application-specific or process-specific software construct serving as a communications endpoint in an operating system of a device. A port is associated with an internet protocol (“IP”) address of the device, as well as the type of protocol (e.g., Transmission Control Protocol (“TCP”)) used for communication.

As used herein, “protocol” is defined as including, but not necessarily being limited to, message formats and rules for exchanging data and information between devices and peripherals on a network. Protocols may include signaling, authentication, and error detection/correction capabilities. A protocol definition includes the syntax, semantics, and synchronization of communication, and may be implemented in hardware, software, or both. Examples of protocols include, without limitation: Hypertext Transfer Protocol (“HTTP”) on port 80, Secure Socket Layer (“SSL”) on port 443, printing on port 9100, file transfer protocol (“FTP”) on port 21, and simple network management protocol (“SNMP”) on port 161. As used herein, “data” is defined as including, but not necessarily being limited to, characters, numbers, letters, symbols, text, pixels, or other similar information that can be used for a variety of tasks and purposes such as printing, rendering, computing, measuring, converting, displaying, etc.

As used herein, “encryption key” is defined as including, but not necessarily being limited to, a cryptographic method that transforms “plaintext” data or information into “ciphertext” data or information, and/or vice versa during decryption, such as, for example, encrypted key exchange (“EKE”), As used herein, “multiplex” and “multiplexing” are defined as including, but not necessarily being limited to a method of utilizing a port for different network traffic. As used herein, “transceive” is defined as including, but not necessarily being limited to, the capability to both transmit and receive data or information.

Referring again to FIG. 1, communication system 10 includes a network 12 and a server 14 including a port 16 connected to network 12. Communication system 10 also includes a device 18 connected to network 12 that communicates data over network 12 via a printing protocol or an HTTP protocol, generally represented by traffic 20 and arrow 22 in FIG. 1. Communication system 10 additionally includes a communication module 24 that determines whether the data communicated by device 18 includes either the printing protocol or the HTTP protocol. Based upon the determined type of protocol, communication module 24 then establishes either a printing link 26 between device 18 and server 14 via port 16 (for printing protocol) to transceive the data over network 12, as generally represented by double-headed arrow 30 in FIG. 1, or an HTTP link 28 between device 18 and server 14 via same port 16 of server 12 (for HTTP protocol) to transceive the data over network 12, as also generally represented by double-headed arrow 30 in FIG. 1.

Thus, communication module 24 of communication system 10 establishes either printing link 26 or HTTP link 28 based on the content of the traffic 20, rather than based upon the numerical designation of a port. This has several advantages including reducing the amount of code required for sever 14 because only one port 16 is needed for two types of traffic 20, rather two separate ports. It also helps reduce the amount of required network administration because there is only one port 16 that needs to go through any firewalls instead of two. Additionally, it provides seamless compatibility with drivers of legacy devices, as compared to IPP which requires wholesale driver rewriting.

Communication system 10 may additionally include a security module 32 associated with communication module 24 to decrypt either or both printing communication received via printing link 26 and/or HTTP communication received via HTTP link 28. Security module 32 may also be designed to encrypt either of both printing communication transmitted via printing link 26 and/or HTTP communication transmitted via HTTP link 28.

In some examples of communication system 10, server 14 may be embedded in a peripheral 34, such as a printing device. Communication system 10 may additionally include a recording module 36 to store data received over network 12 via printing link 26. This data may be stored by recording module 36, for example, on a document repository 38 or storage array connected to network 12.

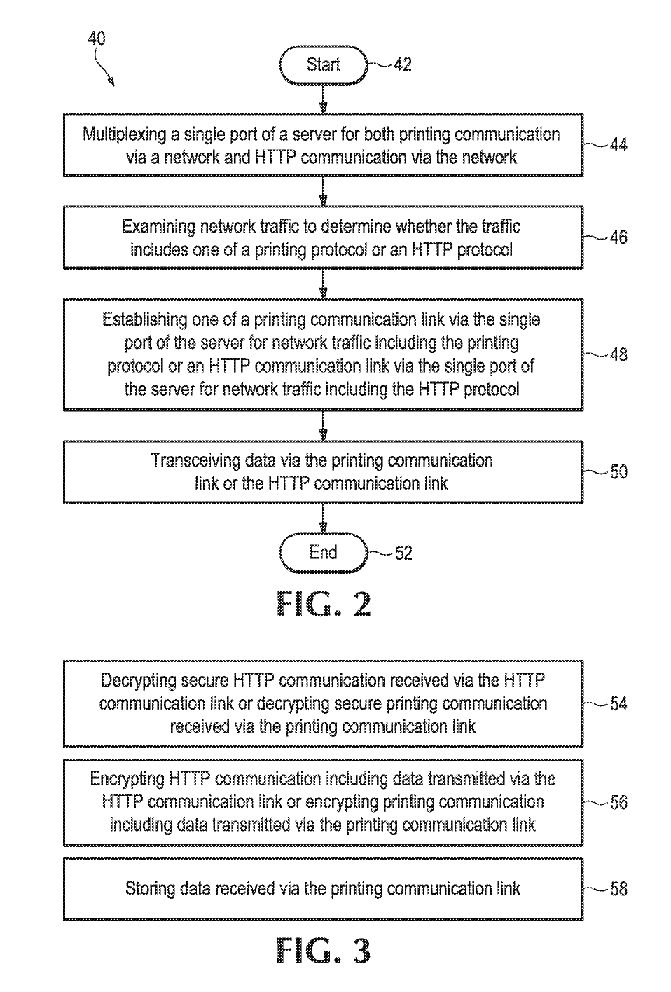

FIG. 2 is an example of a method of network communication 40. As can be seen in FIG. 2, method 40 starts or begins 42 by multiplexing a single port of a server for printing communication via a network and HTTP communication via the network, as indicated by block 44. The server may be embedded in a peripheral. Method 40 continues by examining network traffic to determine whether the traffic includes a printing protocol or an HTTP protocol, as indicated by block 46. HTTP traffic can be identified by the presence of an HTTP verb (e.g., GET, POST, PUT, etc). The data may be further examined to distinguish IPP from a “nominal” HTTP request. If one of the HTTP verbs are present in the initial communication, the identification is further confirmed by checking the validity of the HTTP header section. If the header section is valid, then the link is determined to be HTTP. If the traffic doesn't begin with a verb or the traffic doesn't begin with a valid HTTP header, then the link is determined to be a printing link.

Method 40 additionally continues by establishing a printing communication link via the single port of the server for network traffic including the printing protocol or an HTTP communication link via the single port of the server for network traffic including the HTTP protocol, as indicated by block 48. The printing communication link and/or the HTTP communication link may be wired or wireless. Method 40 further continues by transceiving data via the printing communication link or the HTTP communication link, as indicated by block 50. Method 40 may then end 52.

The communication may be handled in one of two ways: it can either be proxied by HTTP/printing software/firmware, or the link itself may be handed off in implementation specific ways such as passing a socket handle in an embedded implementation. For the proxy approach, an Automatic Multiplexing HTTP/9100 Server (“AMH9S”) can open a link either to a configured HTTP server and then simply relay traffic via the pair of sockets or the proxy could multiplex the link to multiple destinations switch from unencrypted connections to encrypted connections and vice/versa. The HTTP or port 9110 print logic behind the AMH9S receives the traffic from that point on in the same manner as if the AMH9S wasn't involved. For the direct link stream handoff, the involvement of the proxy is complete for this link.

FIG. 3 is an example of additional possible elements of the method of network communication of FIG. 2. As can be seen in FIG. 3, method 40 may include the additional functionality or element of decrypting secure HTTP communication received via the HTTP communication link or decrypting secure printing communication received via the printing communication link, as indicated by block 54. Alternatively or additionally, method 40 may include encrypting HTTP communication including data transmitted via the HTTP communication link or encrypting printing communication including data transmitted via the printing communication link, as indicated by block 56.

Encrypting the HTTP communication may include layering the HTTP protocol with a SSL protocol. Additionally or alternatively, encrypting the printing communication may include either layering the printing protocol with a SSL protocol or creating an encryption key. Furthermore or alternatively, method 40 may include storing data received via the printing communication link, as indicated by block 58. Such storage can occur via a document repository 38 or storage array.

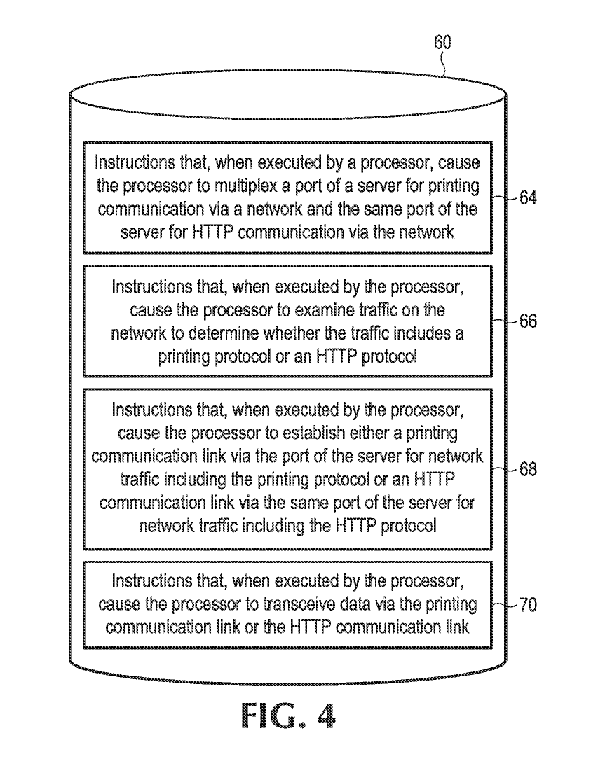

An example of a non-transitory storage medium 60 is shown in FIG. 4. As can be seen in FIG. 1, non-transitory storage medium 60 is connected to network 12 and associated with a processor 62 connected thereto, as generally indicated by doubled-headed dashed arrow 63, to receive and execute instructions stored thereon, as discussed more fully below. Processor 62 may also store/receive data on/from non-transitory storage medium 60, as also generally indicated by doubled-headed dashed arrow 63.

Referring again to FIG. 4, non-transitory storage medium 60 includes instructions that, when executed by processor 62, cause the processor 62 both to multiplex a port of a server for printing communication via a network and the same port of the server for HTTP communication via the network, as generally indicated by block 64, and to examine traffic on the network to determine whether the traffic includes either a printing protocol or an HTTP protocol, as generally indicated by block 66. As can also be seen in FIG. 4, non-transitory storage medium 60 includes additional instructions that, when executed by processor 62, cause processor 62 both to establish either a printing communication link via the port of the server for network traffic including the printing protocol or an HTTP communication link via the same port of the server for network traffic including the HTTP protocol, as generally indicated by block 68, and to transceive data via either the printing communication link or the HTTP communication link, as generally indicated by block 70.

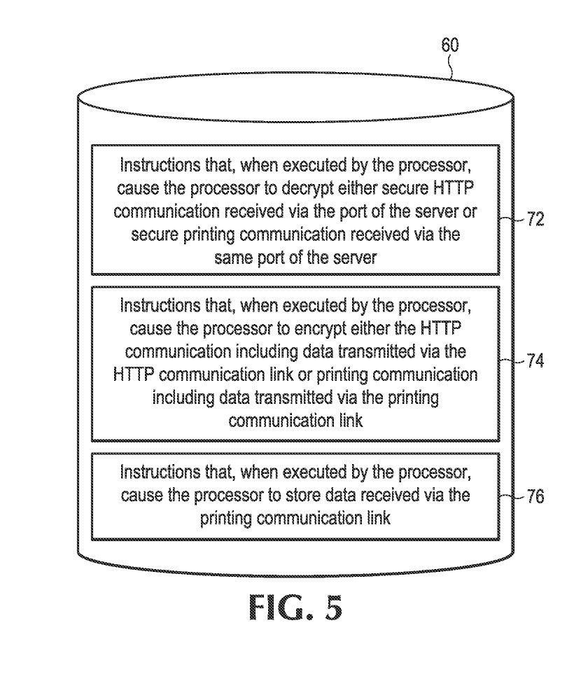

FIG. 5 is an example of additional instructions that may be on non-transitory storage medium 60. As can be seen in FIG. 5, non-transitory storage medium 60 may include instructions that, when executed by processor 62, cause processor to decrypt either secure HTTP communication received via the port of the server or secure printing communication received via the same port of the server. Server 14 and/or processor 62 fray be embedded in a peripheral. Non-transitory storage medium 60 may additionally or alternatively include instructions that, when executed by processor 62, cause processor 62 to encrypt either the HTTP communication including data transmitted via the HTTP communication link or printing communication including data transmitted via the printing communication link. The instructions to encrypt the HTTP communication may include layering the HTTP protocol with a SSL protocol. The instructions to encrypt the printing communication may include either layering the HTTP protocol with a SSL protocol or creating an encryption key.

Non-transitory storage medium 60 may furthermore or alternatively include instructions that, when executed by processor 62, cause processor 62 to store data received via the printing communication link. Such storage can occur via a document repository 38 or storage array. The printing communication link and/or HTTP communication link may be wireless.

Although several examples have been described and illustrated in detail, it is to be clearly understood that the same are intended by way of illustration and example only. These examples are not intended to be exhaustive or to limit the invention to the precise form or to the exemplary embodiments disclosed. Modifications and variations may well be apparent to those of ordinary skill in the art. For example, the various illustrated components such as communication module 24, security module 32, and/or recording module 36 may be implemented in hardware, software, or a combination of the two. The spirit and scope of the present invention are to be limited only by the terms of the following claims.

Additionally, reference to an element in the singular is not intended to mean one and only one, unless explicitly so stated, but rather means one or more. Moreover, no element or component is intended to be dedicated to the public regardless of whether the element or component is explicitly recited in the following claims.

1. An apparatus comprising:
a processor;
a memory on which is stored machine readable instructions that are to cause the processor to:
receive data communicated by a device;
determine whether the data communicated by the device follows one of a first protocol and a second protocol; and
establish, based on the determined type of protocol, one of a first link between the device and a server via a port of the server to transceive the data over a network and a second link between the device and the server via the port of the server to transceive the data over the network.

2. The apparatus of claim 1, wherein the machine readable instructions are further to cause the processor to decrypt of a secure HTTP communication received via the second link and secure printing communication received via the first link, wherein the first link is a printing link and the second link is an HTTP link.

3. The apparatus of claim 1, wherein the machine readable instructions are further to cause the processor to encrypt one of an HTTP communication including data transmitted via the second link and printing communication including data transmitted via the first link, wherein the first link is a printing link and the second link is an HTTP link.

4. The apparatus of claim 1, wherein the server is embedded in a peripheral device.

5. The apparatus of claim 1, wherein the first protocol comprises a printing protocol, the second protocol comprises an HTTP protocol, the first link comprises a printing link, and the second link comprises an HTTP link.

6. A method of network communication, comprising:
examining network traffic to determine whether the network traffic follows one of a first protocol and a second protocol; and
establishing, by a processor, one of a first communication link via a single port of a server for network traffic following the first protocol and a second communication link via the single port of the server for network traffic following the second protocol to enable the server to transceive data via one of the first communication link and the second communication link.

7. The method of claim 6, further comprising one of decrypting a secure communication received via the second communication link and decrypting a secure communication received via the second communication link.

8. The method of claim 6, further comprising one of encrypting an HTTP communication including data transmitted via the second communication link and encrypting a printing communication including data transmitted via the first communication link.

9. The method of claim 8, wherein encrypting the HTTP communication includes layering the second protocol with a SSL protocol, and further wherein encrypting the printing communication includes one of layering the first protocol with a SSL protocol and creating an encryption key.

10. The method of claim 6, wherein the server is embedded in a peripheral device.

11. The method of claim 6, wherein the first protocol comprises a printing protocol, the second protocol comprises an HTTP protocol, the first communication link comprises a printing communication link, and the second communication link comprises an HTTP communication link.

12. The method of claim 6, wherein one of the first communication link and the second communication link is wireless.

13. A non-transitory storage medium, comprising instructions that, when executed by a processor, cause the processor to:
examine traffic on a network to determine whether the traffic follows one of a first protocol and a second protocol;
establish one of a first communication link via a port of a server for network traffic following the first protocol and a second communication link via the port of the server for network traffic following the second protocol to enable the server to transceiver data via one of the first communication link and the second communication link via the same port of the server.

14. The non-transitory storage medium of claim 13, further comprising instructions that, when executed by the processor, cause the processor to decrypt one of a secure HTTP communication received via the port of the server and a secure printing communication received via the same port of the server.

15. The non-transitory storage medium of claim 13, further comprising instructions that, when executed by the processor, cause the processor to encrypt one of an HTTP communication including data transmitted via the second communication link and printing communication including data transmitted via the first communication link.

16. The non-transitory storage medium of claim 15, wherein the instructions to encrypt the HTTP communication include layering the second protocol with a SSL protocol, and further wherein the instructions to encrypt the printing communication include one of layering the first protocol with a SSL protocol and creating an encryption key.

17. The non-transitory storage medium of claim 13, wherein one of the server and the processor is embedded in a peripheral device.

18. The non-transitory storage medium of claim 13, wherein the first protocol comprises a printing protocol, the second protocol comprises an HTTP protocol, the first communication link comprises a printing communication link, and the second communication link comprises an HTTP communication link.

19. The non-transitory storage medium of claim 13, further comprising instructions that, when executed by the processor, cause the processor to store data received via the first communication link.

20. The non-transitory storage medium of claim 13, wherein one of the first communication link and the second communication link is wireless.
